(19) United States
(12) Patent Application Publication
(10) Pub. No.: US 2019/0286208 A1
(43) Pub. Date: Sep. 19, 2019

(54) DISC DEVICE AND METHOD

(71) Applicants: Kabushiki Kaisha Toshiba, Tokyo (JP); Toshiba Electronic Devices & Storage Corporation, Tokyo (JP)

(72) Inventor: Keigo Sogabe, Yokohama Kanagawa (JP)

(21) Appl. No.: 16/127,453

(22) Filed: Sep. 11, 2018

(30) Foreign Application Priority Data
Mar. 19, 2018 (JP) 2018-051552

(51) Int. Cl. G06F 1/30; G06F 3/06; G06F 12/0871

(52) U.S. Cl. CPC G06F 1/30; G06F 12/0871; G06F 3/0631

(57) ABSTRACT

According to an embodiment, a controller of a disc device writes data received from a host device to a disc via a cache area while power from an external power supply is supplied. In a case in which supply of the power from the external power supply is cut off, the controller saves content of a cache area in a nonvolatile memory using regenerative energy generated in a motor that rotates the disc. The controller increases or decreases a size of the cache area based on a temperature detected by a temperature sensor and a writing rate of the nonvolatile memory while the power from the external power supply is supplied.

### CROSS-REFERENCE TO RELATED APPLICATIONS

This application is based upon and claims the benefit of priority from Japanese Patent Application No. 2018-051552, filed on Mar. 19, 2018; the entire contents of which are incorporated herein by reference.

### FIELD

Embodiments described herein relate generally to a disc device and method.

### BACKGROUND

A disc device has a power loss protection (PLP) function. The PLP function is a function of saving data which are in a cache memory to a nonvolatile storage area when power supply from an external power supply is cut off. The data are data which have not been written in a disc.

### BRIEF DESCRIPTION OF THE DRAWINGS

FIG. 1 is a block diagram illustrating an example of a configuration of a disc device according to an embodiment;

FIG. 2 is a diagram illustrating an example of a data configuration of backup time information according to the embodiment;

FIG. 3 is a diagram for description of various types of information stored in a flash read only memory (a flash ROM) according to the embodiment;

FIG. 4 is a flowchart for description of an operation of the disc device according to the embodiment; and

FIG. 5 is a timing chart illustrating a relation between a backup enable signal and a backup execution time according to the embodiment.

### DETAILED DESCRIPTION

According to the present embodiment, a disc device includes one or more discs, a motor, a power supply circuit, a nonvolatile first memory, a volatile second memory, and a controller. The motor rotates the one or more discs. The power supply circuit generates, from first power supplied from an external power supply, second power. The power supply circuit generates, in a case in which supply of the first power is cut off, third power based on regenerative energy generated when the motor stops. The volatile second memory includes a cache area. The controller writes data received from a host device to the one or more discs via the cache area using the second power generated by the power supply circuit while the first power is supplied. The controller saves content of the cache area in the first memory using the third power generated by the power supply circuit in a case in which supply of the first power is cut off. The controller, while the first power is supplied, increases or decreases a size of the cache area based on a temperature detected by a temperature sensor and a writing rate of the first memory.

Hereinafter, a disc device and method according to the embodiment will be described in detail with reference to accompanying drawings. It should be noted that the invention is not limited by this embodiment.

### Embodiment

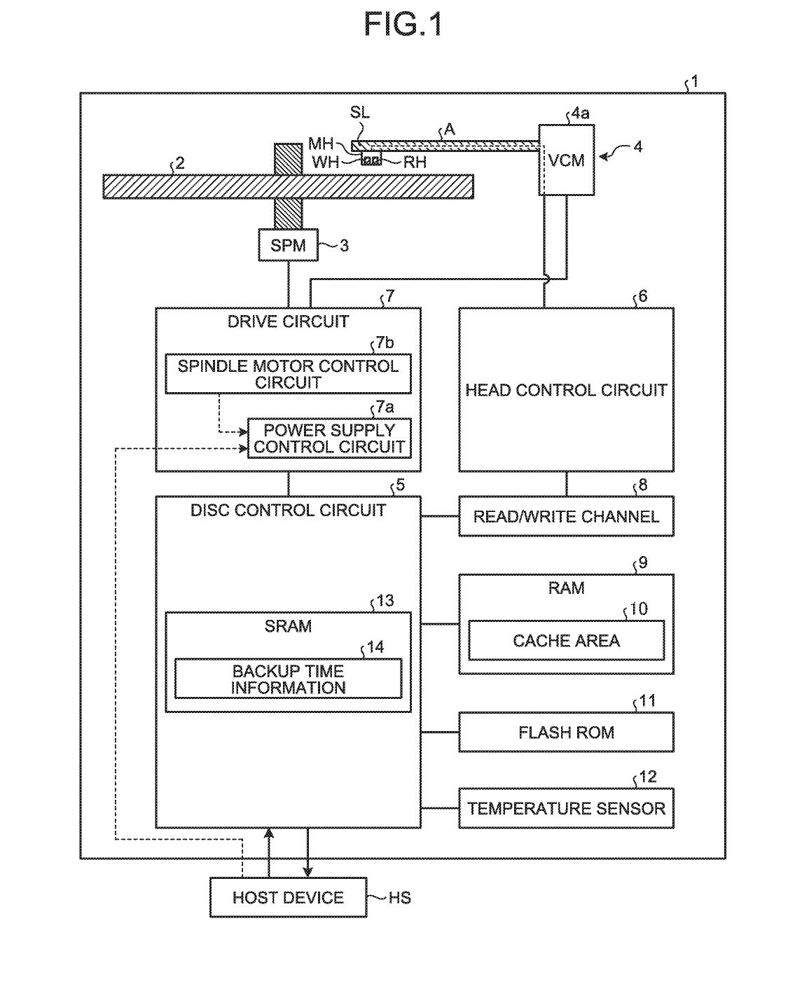

FIG. 1 is a block diagram illustrating an example of a configuration of a disc device according to an embodiment. The disc device 1 functions as an external storage device of a host device HS. The disc device 1 is, for example, a hard disc drive. Specifically, the disc device 1 includes a disc 2, a spindle motor (SPM) 3, a magnetic head MH, an actuator arm A, a voice coil motor (VCM) 4, a disc control circuit 5, a head control circuit 6, a drive circuit 7, a read/write channel 8, a random access memory (RAM) 9, a flash ROM 11, and a temperature sensor 12.

The disc 2 is a disc-shaped recording medium (for example, a magnetic disc) capable of storing various types of information. The disc 2 may also be referred to as a platter. The disc 2 is rotationally driven by the SPM 3. The SPM 3 is an example of a motor that rotates the disc 2.

Even though this diagram illustrates the disc device 1 provided with one disc 2, the number of discs 2 provided in the disc device 1 is not limited to one. A plurality of discs 2 may be provided in one disc device 1. When the plurality of discs 2 are provided in the one disc device 1, the plurality of discs 2 are rotationally driven as a unit.

The magnetic head MH is provided at one end of an actuator arm A to execute writing and reading of data to and from the disc 2. The magnetic head MH has a write head WH for writing data to the disc 2 and a read head RH for reading data from the disc 2. The magnetic head MH is supported on a slider SL and moves in a down track direction on a surface of the disc 2 while maintaining a slightly floating state from the surface of the disc 2 by a lifting force generated by rotation of the disc 2.

The VCM 4 is provided at an end of the actuator arm A on an opposite side from an end at which the magnetic head MH is provided. The VCM 4 rotationally drives the actuator arm A about a shaft 4a. In this way, the VCM 4 moves the magnetic head MH in a cross track direction, and changes a track for writing or reading data on the disc 2.

The RAM 9 is an example of a volatile second memory. The RAM 9 includes a dynamic random access memory (DRAM), a static random access memory (SRAM), a combination thereof, etc. A cache area 10 is allocated in the RAM 9. That is, the RAM 9 functions as a cache memory. The cache area 10 is a storage area that temporarily stores data not yet written to the disc 2 among data received from the host device HS.

The head control circuit 6 executes writing of data to the disc 2 by transmitting a write signal (current) corresponding to data input from the read/write channel 8 to the write head WH. Further, the head control circuit 6 amplifies a read signal (data read from the disc 2 by the read head RH) output from the read head RH, and supplies the amplified read signal to the read/write channel 8.

The read/write channel 8 performs code-modulation on data stored in the cache area 10, and outputs the data subjected to the code-modulation to the head control circuit 6. In addition, the read/write channel 8 performs code-demodulation on data transmitted from the head control circuit 6, and outputs the data subjected to the code-demodulation to the disc control circuit 5.

The drive circuit 7 controls power supply to the disc device 1. Further, the drive circuit 7 controls driving of the VCM 4. The drive circuit 7 has a power supply control circuit 7a and a spindle motor control circuit 7b. The spindle motor control circuit 7b controls rotation of the SPM 3.

The power supply control circuit 7a is an example of a power supply circuit. The power supply control circuit 7a receives supply of power from the host device HS (an example of an external power supply) and generates power to drive each part of the disc device 1 based on the supplied power. For example, generating power includes a process such as rectification, stepping-up, or stepping-down. The power supply control circuit 7a supplies the generated power to each part of the disc device 1. The power supply control circuit 7a may supply the supplied power to each part without change.

In addition, when supply of power from the host device HS is cut off, the power supply control circuit 7a can detect that the supply of power from the host device HS is cut off. In the case of detecting that the supply of power from the host device HS is cut off, the power supply control circuit 7a receives regenerative energy generated in the SPM 3 via the spindle motor control circuit 7b. Then, the power supply control circuit 7a generates power based on the regenerative energy received from the SPM 3, and supplies the generated power to each part of the disc device 1.

During rotation of the disc 2, a supply current to the SPM 3 is stopped. Energy resulting from a counter electromotive force of the SPM 3 is recovered by the spindle motor control circuit 7b as regenerative energy. In addition, kinetic energy of the rotating disc 2 is converted into electric energy by the SPM 3, and the electric energy is recovered by the spindle motor control circuit 7b as regenerative energy.

As described above, the power supply control circuit 7a generates power supplied to each part based on the regenerative energy generated when the SPM 3 is stopped. Therefore, the disc device 1 can operate using the regenerative energy for a while after the supply of power from the host device HS is cut off. During this period, processing of the PLP function is executed in the disc device 1.

The PLP function is a function of preventing data in the cache memory from being lost from the disc device 1 by saving the data to a nonvolatile memory in the case of detecting that supply of power from the host device HS is cut off. In the case of the embodiment, as processing of the PLP function, data in the cache area 10 is saved to the flash ROM 11. The saving may correspond to a transfer or a copy. The saving may include a process of processing data, such as compression, encoding, or format conversion. Hereinafter, a process of saving data in the cache area 10 to the flash ROM 11 may be referred to as backup.

In the case of detecting supply of power from the host device HS is cut off, the power supply control circuit 7a asserts a backup enable signal. The backup enable signal is a signal indicating that backup can be executed, and is supplied to the disc control circuit 5. After asserting the backup enable signal, the power supply control circuit 7a negates the backup enable signal when a voltage supplied to each part becomes lower than a certain threshold value.

The threshold value can be arbitrarily set as long as the threshold value is larger than a voltage value required for the disc control circuit 5 to execute backup. For example, the voltage value required for the disc control circuit 5 to execute backup may be set as the threshold value. A value obtained by adding a certain margin to the voltage value required for the disc control circuit 5 to execute backup may be set as the threshold value. A value larger than the voltage value required for the disc control circuit 5 to execute backup and smaller than a voltage value required for accessing (writing, reading) the disc 2 may be set as the threshold value.

Hereinafter, the fact that the supply of power from the host device HS is cut off may be referred to as power loss.

The temperature sensor 12 is a sensor for detecting a temperature. The disc device 1 includes parts that generate heat, such as the SPM 3, the disc control circuit 5, and the drive circuit 7. Depending on the degree of heat generation of these parts or the temperature around the disc device 1, the temperature inside the disc device 1 increases or decreases. The temperature inside the disc device 1 affects power consumption of the disc device 1, in particular, power consumption during a saving process. For example, in the disc control circuit 5, a leakage current increases in accordance with an increase in the temperature thereof, thereby increasing power consumption. The temperature sensor 12 is disposed in the vicinity of a part that affects power consumption of the disc device 1. Hereinafter, the temperature of the disc device 1 refers to a temperature measured by the temperature sensor 12.

Incidentally, the number of the temperature sensors 12 provided in the disc device 1 is not limited to one. A plurality of temperature sensors 12 may be disposed in the disc device 1 and one value indicating the temperature of the disc device 1 may be calculated based on a plurality of values obtained by the plurality of temperature sensors 12.

The disc control circuit 5 is an example of a controller. The disc control circuit 5 may include a central processing unit (CPU), a logic circuit, or both the CPU and the logic circuit. The disc control circuit 5 controls the entire disc device 1 according to a command received from the host device HS.

While receiving supply of power from the host device HS, the disc control circuit 5 executes a normal operation using the power supplied from the power supply control circuit 7a. The normal operation includes transmission and reception of a command and data to and from the host device HS and access (writing and reading) to the disc 2.

For example, in the normal operation, upon receiving data requested to be written by a write command from the host device HS, the disc control circuit 5 stores the received data in the cache area 10. The disc control circuit 5 causes the read/write channel 8 to write the data in the cache area 10 to the disc 2. In other words, the disc control circuit 5 writes the data received from the host device HS to the disc 2 via the cache area 10. Further, the disc control circuit 5 transmits data output from the read/write channel 8 to the host device HS.

When power loss occurs, the disc control circuit 5 terminates the normal operation and executes backup related to the PLP function. The occurrence of power loss is reported from the power supply control circuit 7a. The disc control circuit 5 can execute backup in a period during which the backup enable signal is asserted after receiving notification of the occurrence of power loss. The disc control circuit 5 executes backup using power supplied from the power supply control circuit 7a, that is, power generated from regenerative energy generated when the SPM 3 is stopped.

In the normal operation, the disc control circuit 5 can start processing of a subsequent command before writing of all data in the cache area 10 to the disc 2 is completed. Therefore, as capacity of the cache area 10 increases, performance of the disc device 1 improves. However, when the capacity of the cache area 10 is larger than the amount of data that can be saved at the time of backup, it may be impossible to save all the data in the cache area 10 when power loss occurs.

Therefore, in the embodiment, a size of the cache area 10 is configured to be changeable (variable or adjustable). Further, the disc control circuit 5 estimates the amount of data that can be saved at the time of backup, and sets the amount obtained by the estimation as the size of the cache area 10.

As described above, backup is executed based on regenerative energy generated when the SPM 3 is stopped. The amount of regenerative energy depends on the mass and the number (rotational speed) of rotations of the disc 2. The number of rotations of the disc 2 at the time of writing data is determined for each disc device 1. The mass of the disc 2 is determined according to the number of the discs 2 provided in the disc device 1. Therefore, the amount of power supplied to each part which can be generated from regenerative energy is determined for each disc device 1.

In contrast, the amount of data that can be saved per unit power amount increases or decreases depending on the temperature of the disc device 1 and the writing rate of the flash ROM 11. For example, as the temperature of the disc device 1 increases, power consumption increases. As the power consumption increases, a time length during which backup can be executed per unit power amount becomes shorter, and the amount of data that can be saved decreases accordingly. Further, as the writing rate of the flash ROM 11 is higher, the amount of data that can be saved per unit time increases, and thus the amount of data that can be saved per unit power amount increases.

The disc control circuit 5 estimates a time length during which backup can be executed based on at least the temperature of the disc device 1. Then, the disc control circuit 5 estimates the amount of data that can be saved within the estimated time length based on the writing rate to the flash ROM 11. Then, the disc control circuit 5 calculates the amount of data that can be saved within the estimated time length as a set value of the size of the cache area 10.

The disc control circuit 5 further includes an SRAM 13. The SRAM 13 is an example of a third memory. Information used for various processes by the disc control circuit 5 is stored in the SRAM 13. In particular, backup time information 14 is stored in the SRAM 13.

The backup time information 14 is information indicating a correspondence among the temperature of the disc device 1, the number of discs 2 provided in the disc device 1, and the estimated value of the time length during which backup can be executed. For example, the backup time information 14 is stored in a nonvolatile storage area such as the flash ROM 11 or the disc 2. The disc control circuit 5 loads the backup time information 14 from the storage area in the SRAM 13 at the time of startup. The disc control circuit 5 estimates the time length during which backup can be executed using the backup time information 14 loaded in the SRAM 13.

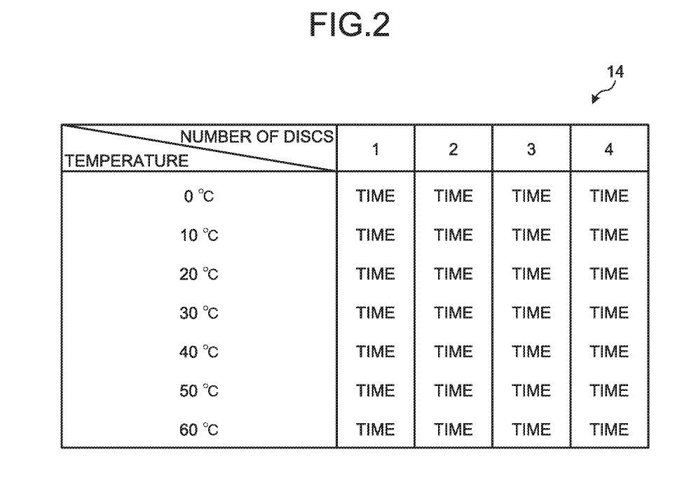

FIG. 2 is a diagram illustrating an example of a data configuration of the backup time information 14 according to the embodiment. According to this example, the backup time information 14 corresponds to a table in which an estimated value of the time length during which backup can be executed is recorded in each cell. A row of this table is selected according to the temperature of the disc device 1. A column of this table is selected according to the number of discs 2 provided in the disc device 1. The disc control circuit 5 acquires an estimated value of the time length during which backup can be executed by retrieving the backup time information 14 using the temperature of the disc device 1 and the number of discs 2 provided in the disc device 1 as search keys.

Incidentally, the data configuration of the backup time information 14 is not limited thereto. The backup time information 14 may be configured by a function.

For example, the number of discs 2 included in the disc device 1 is recorded in a nonvolatile storage area such as the flash ROM 11 or the disc 2 at the time of manufacturing the disc device 1. The disc control circuit 5 acquires the number of discs 2 from the storage area and uses the acquired number of discs 2 for retrieving the backup time information 14.

Further, the disc control circuit 5 can acquire a writing rate of the flash ROM 11 by two methods.

According to a first method, the disc control circuit 5 acquires a specification worst value of the flash ROM 11, and regards the acquired specification worst value as the writing rate. The specification worst value of the flash ROM 11 is a worst value of a writing rate defined by a specification of the flash ROM 11. For example, the specification worst value is previously recorded in a nonvolatile storage area such as the flash ROM 11 or the disc 2, and the disc control circuit 5 acquires the specification worst value from the storage area. The disc control circuit 5 acquires the writing rate of the flash ROM 11 using this method at a first startup. The first startup refers to a startup in a state in which backup has never been executed.

According to a second method, at the time of saving data in the flash ROM 11, the disc control circuit 5 generates a time stamp (time stamp 17) each time data of a certain size is written to the flash ROM 11, and records the time stamp in the flash ROM 11. For example, the time stamp corresponds to an elapsed time after backup starts. Subsequently, when the disc device 1 starts up, that is, when power from the host device HS is subsequently supplied, the disc control circuit 5 calculates the writing rate of the flash ROM 11 by dividing the certain size by a time interval indicated by two consecutive time stamps. According to this method, it is possible to acquire an actual value of the writing rate of the flash ROM 11. At the time of second and subsequent startups, the disc control circuit 5 acquires the writing rate of the flash ROM 11 using this method. The second and subsequent startups refer to startups in a state in which backup has been executed in a previous operation.

The flash ROM 11 is an example of a nonvolatile first memory. For example, the flash ROM 11 includes a NAND type flash memory, a NOR type flash memory, etc. Data in the cache area 10 is saved in the flash ROM 11 by backup. In the flash ROM 11, the data in the cache area 10 is saved, and arbitrary data may be stored.

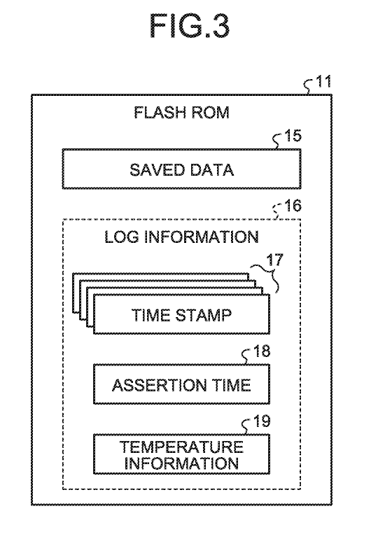

FIG. 3 is a diagram for description of various types of information stored in the flash ROM 11 according to the embodiment. As illustrated in the drawing, the flash ROM 11 stores data (saved data 15) saved from the cache area 10 and log information 16. The log information 16 includes a time stamp (time stamp 17), an assertion time 18, and temperature information 19 described above.

The assertion time 18 indicates a time length from when a backup enable signal is asserted until the backup enable signal is negated. The temperature information 19 corresponds to a temperature of the disc device 1 at the time of execution of backup. The disc control circuit 5 records the assertion time 18 and the temperature information 19 at the time of executing the backup. Then, when the disc device 1 subsequently starts up, the disc control circuit 5 updates the backup time information 14 using the assertion time 18 and the temperature information 19.

Next, a description will be given of an operation of the disc device 1 according to the embodiment.

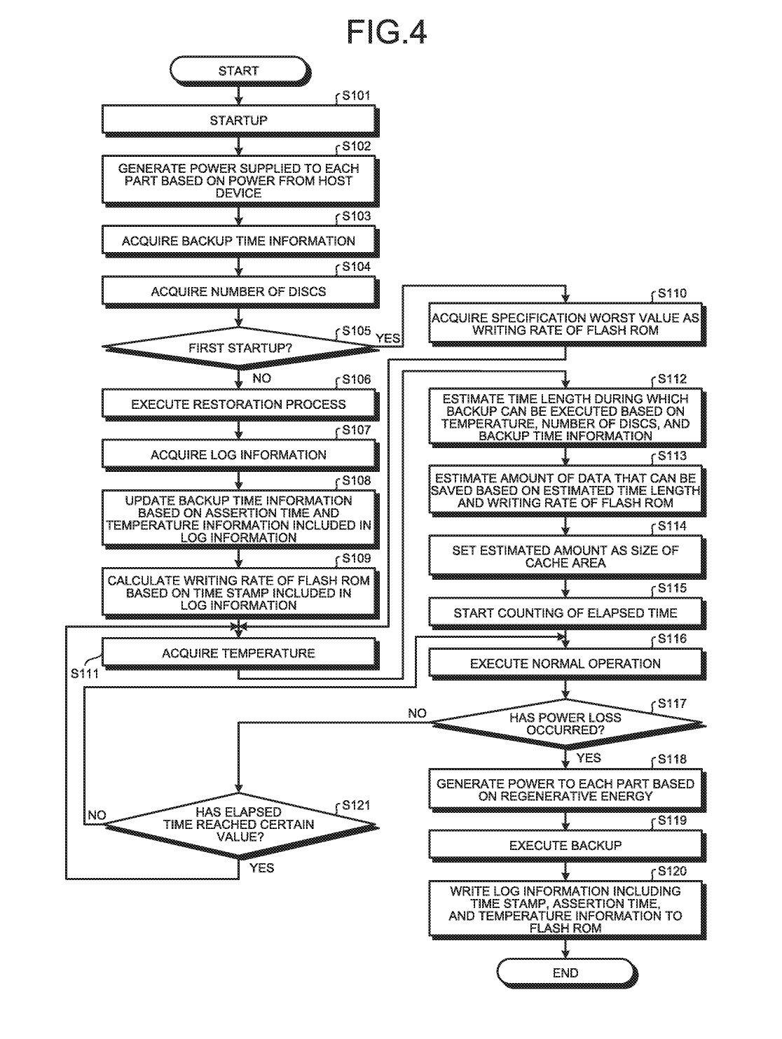

FIG. 4 is a flowchart for description of the operation of the disc device 1 according to the embodiment. First, the disc device 1 is started up (S101). Then, the power supply control circuit 7a generates power supplied to each part based on power supplied from the host device HS (S102).

The disc control circuit 5 acquires the backup time information 14 in the SRAM 13 (S103). The disc control circuit 5 acquires the number of discs 2 provided in the disc device 1 (S104).

Subsequently, the disc control circuit 5 determines whether a current startup corresponds to a first startup (S105).

The disc control circuit 5 can execute determination of S105 by an arbitrary method. For example, the disc control circuit 5 may record the number of startups in the log information 16, store the log information 16 in the flash ROM 11, and execute the determination of S105 based on the log information 16 stored in the flash ROM 11.

When the current startup does not correspond to the first startup (S105, No), the disc control circuit 5 executes a restoration process (S106). In the restoration process, the saved data 15 stored in the flash ROM 11 is restored in the cache area 10. The data restored in the cache area 10 are successively written to the disc 2.

Subsequently, the disc control circuit 5 acquires the log information 16 from the flash ROM 11 (S107), and updates the backup time information 14 based on the assertion time 18 and the temperature information 19 recorded in the log information 16 (S108).

For example, in S108, the disc control circuit 5 compares a value (hereinafter retrieval value) recorded in a cell located at an intersection of a column selected by the number of the discs 2 obtained by processing of S104 and a row selected by the temperature information 19 among cells included in the backup time information 14 with the assertion time 18. When the value is different from the assertion time 18, the disc control circuit 5 overwrites content of the cell with the assertion time 18. When the value corresponds to the assertion time 18, the disc control circuit 5 does not change the content of the cell.

In another example, the disc control circuit 5 compares a value obtained by subtracting a margin from the assertion time 18 with the retrieval value. When the value obtained by subtracting the margin from the assertion time 18 is larger than the retrieval value, the disc control circuit 5 overwrites content of a cell in which the retrieval value is recorded with the value obtained by subtracting the margin from the assertion time 18. When the value obtained by subtracting the margin from the assertion time 18 is equal to or less than the retrieval value, the disc control circuit 5 does not execute overwriting.

In still another example, when the retrieval value is different from the assertion time 18, the disc control circuit 5 multiplies a value obtained by dividing the assertion time 18 by the retrieval value by a value of all cells belonging to the same column as that of the cell in which the retrieval value is recorded.

In this way, updating of the backup time information 14 can be realized in various methods.

Subsequently, the disc control circuit 5 calculates the writing rate of the flash ROM 11 based on the time stamp 17 recorded in the log information 16 (S109)

When the current startup corresponds to the first startup (S105, Yes), the log information 16 is not present. Therefore, the disc control circuit 5 acquires the specification worst value of the flash ROM 11 as the writing rate of the flash ROM 11 (S110).

After processing of S109 or S110, the disc control circuit 5 acquires a temperature detection value from the temperature sensor 12 (S111). Then, the disc control circuit 5 acquires an estimated value of the time length during which backup can be executed by retrieving the backup time information 14 using the number of discs 2 acquired by processing of S104 and the temperature detection value acquired by processing of S111 as search keys (S112). Then, the disc control circuit 5 acquires an estimated value of the amount of data that can be saved by dividing the estimated value of the time length during which backup can be executed by the writing rate acquired by processing of S109 or S110 (S113).

After processing of S113, the disc control circuit 5 sets the estimated value of the amount of data that can be saved as the size of the cache area 10 (S114). Then, the disc control circuit 5 starts counting of an elapsed time (S115) and executes the normal operation (S116).

Here, the size of the cache area 10 is set by processing of S114. In the normal operation, when the cache area 10 becomes full, that is, when the amount of data received from the host device HS and not yet written to the disc 2 reaches the value set by processing of S114, the disc control circuit 5 suspends receiving of new data from the host device HS until a vacant area is generated in the cache area 10.

When power loss occurs at the time of execution of the normal operation (S117, Yes), the power supply control circuit 7a generates power based on regenerative energy and supplies the generated power to each part (S118). In addition, the power supply control circuit 7a maintains the backup enable signal in an asserted state during a period during which backup can be executed.

While the backup enable signal is maintained in the asserted state, the disc control circuit 5 executes backup (S119). That is, the disc control circuit 5 saves the data in the cache area 10 to the flash ROM 11. In addition, the disc control circuit 5 writes the log information 16 including the time stamp 17, the assertion time 18, and the temperature information 19 to the flash ROM 11 (S120). Then, the disc device 1 stops the operation.

When power loss does not occur (S117, No), and a count value of the elapsed time reaches a certain value (for example, 60 seconds) (S121, Yes), the control proceeds to S111. When power loss does not occur (S117, No), and the count value of the elapsed time does not reach the certain value (for example, 60 seconds) (S121, No), the control proceeds to S116.

As described above, according to the embodiment, the power supply control circuit 7a generates power supplied to each part from power from the external power supply. When power loss occurs, the power supply control circuit 7a generates power supplied to each part based on regenerative energy generated at the time of stopping the SPM 3. While power is supplied from the external power supply, the disc control circuit 5 increases or decreases the size of the cache area 10 based on the temperature detected by the temperature sensor 12 and the writing rate of the flash ROM 11.

As described above, the amount of data that can be saved at the time of backup varies according to the temperature of the disc device 1 and the writing rate of the flash ROM 11. For example, in the case of determining the size of the cache area 10 at the time of manufacture, considering that the amount of data that can be saved at the time of backup varies, a minimum value of a range of change in the amount of data may be set as the size of the cache area 10. On the other hand, in the present embodiment, according to the above configuration, the size of the cache area 10 can be made close to the amount of data that can be saved at the time of backup. Therefore, according to the present embodiment, it is possible to increase the size of the cache area 10 when compared to a case in which the size of the cache area 10 is fixed at the time of manufacture. Therefore, the performance of the disc device 1 is improved.

In addition, the disc control circuit 5 calculates a set value of the size of the cache area 10 based on the number of the discs 2 provided in the disc device 1, the temperature of the disc device 1 detected by the temperature sensor 12, and the writing rate of the flash ROM 11.

According to this configuration, in the case of manufacturing a plurality of disc devices 1 having different numbers of discs 2 mounted thereon, it is unnecessary to change a function of the disc control circuit 5 for each number of the mounted discs 2.

Incidentally, the disc control circuit 5 estimates the time length during which backup can be executed based on the number of discs 2 provided in the disc device 1 and the temperature of the disc device 1 detected by the temperature sensor 12, and acquires the set value of the size of the cache area 10 by multiplying the estimated time by the writing rate of the flash ROM 11.

A method of acquiring the set value of the size of the cache area 10 is not limited thereto. For example, the disc control circuit 5 may acquire the set value of the size of the cache area 10 based on information (for example, a table) indicating a correspondence among the number of discs 2 provided in the disc device 1, the temperature of the disc device 1 detected by the temperature sensor 12, the writing rate of the flash ROM 11, and the size of the cache area 10.

In addition, at the time of saving the data in the cache area 10 to the flash ROM 11, the disc control circuit 5 generates a time stamp each time a certain amount of data is saved, and records the time stamp in the flash ROM 11. Then, when the disc device 1 is subsequently started up, the disc control circuit 5 calculates the writing rate of the flash ROM 11 based on the time stamp recorded in the flash ROM 11.

According to this configuration, even when the writing rate of the flash ROM 11 varies individually or over time, it is possible to increase the size in the cache area 10 according to the actual value of the writing rate of the flash ROM 11 provided in the disc device 1.

Incidentally, the method of recording the time stamp each time a certain amount of data is saved is an example of a method of measuring the actual value of the writing rate of the flash ROM 11. The disc control circuit 5 can measure the actual value of the writing rate of the flash ROM 11 using an arbitrary method. For example, the disc control circuit 5 may record, in the flash ROM 11, arbitrary information related to the writing rate of the flash ROM 11 such as an interval of writing commands sent to the flash ROM 11 at the time of execution of backup, and calculate the writing rate of the flash ROM 11 using the information at the time of subsequent startup.

When the log information 16 is not recorded, the actual value of the writing rate of the flash ROM 11 may not be obtained. Therefore, when the disc device 1 is started up for the first time, the disc control circuit 5 uses the specification worst value of the flash ROM 11 as the writing rate of the flash ROM 11. Therefore, when the disc device 1 is started up for the first time, it is possible to set the size of the cache area 10 so that the data in the cache area 10 can be surely saved irrespective of a variation in the writing rate of the flash ROM 11.

In addition, the disc control circuit 5 acquires the temperature from the temperature sensor 12 at a certain time interval and updates the set value of the size of the cache area 10 using the temperature.

Therefore, even when the temperature changes during operation of the disc device 1, it is possible to appropriately adjust the size of the cache area 10 to a maximum size that can be used under the circumstances.

In addition, at the time of execution of backup, the disc control circuit 5 records the assertion time 18 of the backup enable signal issued by the power supply control circuit 7a. Then, when the disc device 1 is subsequently started up, a corresponding value recorded in the backup time information 14 is updated using the assertion time 18.

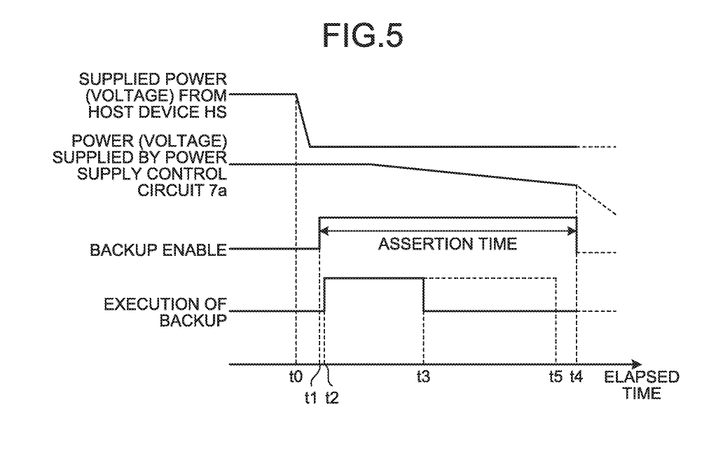

FIG. 5 is a timing chart illustrating a relation between the backup enable signal and the backup execution time according to the embodiment. In this timing chart, a transition of a voltage value is further depicted for each of power supplied from the host device HS and power supplied to each part by the power supply control circuit 7a.

When power loss occurs at time t0, the power supply control circuit 7a generates the power supplied to each part based on regenerative energy. Therefore, the power supply control circuit 7a can supply power without fluctuation of voltage before and after occurrence of power loss. After power loss is detected, the power supply control circuit 7a asserts the backup enable signal (time t1). When a voltage value of the generated power falls below a certain value, the power supply control circuit 7a negates the backup enable signal (time t4). When the backup enable signal is asserted, the disc control circuit 5 starts backup (time t2) and terminates the backup before time t4 when the backup enable signal is negated (time t3).

The disc control circuit 5 records a period from time t1 to time t4 as the assertion time 18 and updates the backup time information 14 using the assertion time 18. In this way, for example, at the time of subsequent backup, it is possible to continue a backup process up to, for example, time t5 immediately before time t4. That is, even when the backup time information 14 prepared in advance is inaccurate, it is possible to correct the backup time information 14 so that the size of the cache area 10 can be increased as much as possible.

A description has been given on the assumption that the backup time information 14 is stored in, for example, the nonvolatile storage area such as the flash ROM 11 or the disc 2, and is loaded from the storage area in the SRAM 13. When the backup time information 14 loaded in the SRAM 13 is updated, the disc control circuit 5 may overwrite the backup time information 14 in the nonvolatile storage area with the updated backup time information 14. As a result, it is possible to use the updated backup time information 14 at the time of the subsequent startup.

Incidentally, in the disc device, an enclosure is hermetically sealed and helium is filled therein in some cases. When the disc device is filled with helium, a frictional resistance of the SPM decreases, and a calorific value in the SPM decreases. In addition, regenerative energy generated when the SPM stops increases. That is, in a case in which helium is filled in the inside of the disc device, the disc device may save more data at the time of backup when compared to a case in which air is filled in the inside.

Since the disc device 1 adjusts the size of the cache area 10 according to the temperature of the disc device 1 or the assertion time 18, it is possible to increase the size of the cache area 10 as much as possible regardless of whether gas filled in the disc device 1 is air or helium. That is, it becomes unnecessary for a manufacturer to change a function of the disc control circuit 5 depending on whether the gas filled in the disc device 1 is air or helium.

In addition, when helium filled in the disc device 1 leaks due to an accident, the disc device 1 automatically adjusts the size of the cache area 10 according to the temperature of the disc device 1 or the assertion time 18. Therefore, even in such a case, it is possible to prevent data from being lost from the disc device 1 at the time of backup.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disc device comprising:
one or more discs;
a motor that rotates the one or more discs;
a power supply circuit that generates, from first power supplied from an external power supply, second power, and, in a case in which supply of the first power is cut off, generates third power based on regenerative energy generated when the motor stops;
a nonvolatile first memory;
a volatile second memory including a cache area; and
a controller that writes data received from a host device to the one or more discs via the cache area using the second power generated by the power supply circuit while the first power is supplied, and saves content of the cache area in the first memory using the third power generated by the power supply circuit in a case in which supply of the first power is cut off,
wherein the controller, while the first power is supplied, increases or decreases a size of the cache area based on a temperature detected by a temperature sensor and a writing rate of the first memory.

2. The disc device according to claim 1, wherein the controller calculates a set value of the size of the cache area based on a number of discs included in the one or more discs, the temperature, and the writing rate, and updates the size of the cache area with the set value.

3. The disc device according to claim 2, wherein the controller estimates, based on the number of discs and the temperature, a first time length during which saving the content is executable, and multiplies the first time length by the writing rate to acquire the set value.

4. The disc device according to claim 1, wherein the controller writes first information related to a writing amount and a writing time length to the first memory when the content of the cache area is saved in the first memory, and calculates the writing rate based on the first information when supply of the first power is subsequently resumed.

5. The disc device according to claim 4, wherein the controller generates a time stamp as the first information each time data of a certain amount is saved in the first memory, and writes the time stamp to the first memory.

6. The disc device according to claim 4, wherein when the disc device is started up for a first time, the controller acquires a worst value defined by a specification of the first memory as the writing rate.

7. The disc device according to claim 2, wherein the controller acquires the temperature from the temperature sensor at a certain time interval, and sets the size of the cache area each time the temperature is acquired from the temperature sensor.

8. The disc device according to claim 3, further comprising
a third memory that stores first information indicating a correspondence between the number and a temperature of discs and the first time length,
wherein the controller acquires the first time length based on the first information.

9. The disc device according to claim 8,
wherein in a case in which supply of the first power is cut off, the power supply circuit notifies the controller of a second time length during which saving the content is executable based on a voltage value of the third power,
in a case in which supply of the first power is cut off, the controller saves the content of the cache area in the first memory within the second time length, writes the second time length to the first memory, and
in a case in which supply of the first power is subsequently resumed, the controller updates the first information using the second time length.

10. The disc device according to claim 9, wherein the disc device is filled with helium.

11. A method of controlling a disc device including a cache area, a nonvolatile memory, one or more discs, and a motor that rotates the one or more discs, the method comprising:
generating, from first power supplied from an external power supply, second power;
increasing or decreasing a size of the cache area based on a temperature of the disc device and a writing rate of the nonvolatile memory;
writing data received from a host device to the one or more discs via the cache area using the second power;
generating, in a case in which supply of the first power is cut off, third power based on regenerative energy generated when the motor stops; and
saving, in a case in which supply of the first power is cut off, content of the cache area in the nonvolatile memory using the third power.

12. The method according to claim 11, wherein the increasing or decreasing of the size of the cache area includes calculating a set value of the size of the cache area based on a number of discs included in the one or more discs, the temperature, and the writing rate, and updating the size of the cache area with the set value.

13. The method according to claim 12, wherein the calculating of the set value includes estimating a first time length during which saving is executable based on the number of discs and the temperature, and acquiring the set value by multiplying the estimated first time length by the writing rate.

14. The method according to claim 11, further comprising
writing first information related to a writing amount and a writing time length to the nonvolatile memory when the content of the cache area is saved in the nonvolatile memory, and calculating the writing rate based on the first information when supply of the first power is subsequently resumed.

15. The method according to claim 14, further comprising
generating a time stamp as the first information each time data of a certain amount is saved in the nonvolatile memory, and writing the time stamp to the nonvolatile memory.

16. The method according to claim 14, further comprising
acquiring a worst value defined by a specification of the nonvolatile memory as the writing rate when the disc device is started up for a first time.

17. The method according to claim 12, further comprising
acquiring the temperature from a temperature sensor at a certain time interval, and setting the size of the cache area each time the temperature is acquired from the temperature sensor.

18. The method according to claim 13, further comprising
acquiring the first time length based on first information indicating a correspondence among a number of discs, a temperature and a first time length.

19. The method according to claim 18, further comprising
acquiring, in a case in which supply of the first power is cut off, a second time length during which saving of the content is executable based on a voltage value of the third power;
in a case in which supply of the first power is cut off, saving the content of the cache area in the nonvolatile memory within the second time length, and writing the second time length to the nonvolatile memory; and
in a case in which supply of the first power is subsequently resumed, updating the first information using the second time length.

20. The method according to claim 19, wherein the disc device is filled with helium.
